(19) United States
(12) Patent Application Publication
(10) Pub. No.: US 2026/0075424 A1
(43) Pub. Date: Mar. 12, 2026

(54) System and method for detecting and mitigating unauthorized access and tampering with respect to a device

(71) Applicant: Bank of America Corporation, Charlotte, NC (US)

(72) Inventors: Adam King, Fort Mill, SC (US); Coreen Marks, North Myrtle Beach, SC (US); Karishma Batra, Flintshire (GB); James Edward Bowden, Cheshire (GB); Camilla Solideo, Chicago, IL (US); Racquel Butler, Pineville, NC (US)

(21) Appl. No.: 18/827,997

(22) Filed: Sep. 9, 2024

(51) Int. Cl. H04W 12/30; H04L 9/32

(52) U.S. Cl. CPC H04W 12/30; H04L 9/3297

(57) ABSTRACT

A system for detecting and mitigating unauthorized access and tampering with respect to a device is disclosed. The system detects an event that indicates an attempt to access a portable device, where detecting the event comprises detecting a mixed signal associated with an external device. The system determines a set of frequencies associated with the mixed signal. The system compares a first frequency from the mixed signal with a set of authorized frequencies. The system determines that the first frequency is not among the set of authorized frequencies. In response, the system determines that the first frequency is associated with a malicious device. The system performs one or more countermeasure actions.

### TECHNICAL FIELD

The present disclosure relates generally to network security, and more specifically to a system and method for detecting and mitigating unauthorized access and tampering with respect to a device.

### BACKGROUND

Portable devices are used to communicate with other devices. For example, a portable device may be used to communicate data with another device using a near-field communication protocol.

### SUMMARY

The disclosed system, described in the present disclosure, is particularly integrated into a practical application of improving the unauthorized access attempt detection and mitigation techniques with respect to unauthorized attempts to remotely access portable devices.

In the current systems, skimming devices pose an ongoing threat, resulting in compromised data. Existing security measures necessitate the development of more robust solutions to safeguard against this form of fraud. The disclosed system is configured to provide a technical solution to these and other technical problems in the realm of data and network security. In some embodiments, the disclosed system provides anti-skimming technology embedded within the portable device. The portable device may employ a combination of dynamic security features to protect data that is accessible at and/or via the portable device. For example, in some embodiments, the disclosed system may be configured to implement stealth mode activation, frequency jamming, randomized data encryption, dynamic magnetic stripe, and tamper detection mechanisms.

By implementing these technologies, the portable device remains inaccessible to skimming devices, disrupts the functioning of the skimming devices, reduces the likelihood of data capture attempts from the skimming devices, reduces the likelihood of duplication of information stored in a memory of the portable device and information accessible via the portable device, and addresses any tampering attempts by the skimming devices. In this way, the disclosed system improves the detection and mitigation techniques for unauthorized access attempts via skimming devices. This, in turn, improves the network security techniques by detecting and mitigating remote access attempts from malicious devices that may be used to exfiltrate data accessible at and/or via portable devices.

In some embodiments, a system comprises a memory operably coupled with a processor. The memory is configured to store a set of authorized frequencies associated with an authorized device. The processor is configured to detect an event that indicates an attempt to access a portable device, wherein detecting the event comprises detecting a mixed-frequency signal associated with at least an external device. The processor is further configured to determine that a set of frequencies associated with the mixed-frequency signal comprises a first frequency. The processor is further configured to compare the first frequency with the set of authorized frequencies. The processor is further configured to determine that the first frequency is not among the set of authorized frequencies. The processor is further configured to determine that the first frequency is associated with a malicious device in response to determining that the first frequency is not among the set of authorized frequencies. The processor is further configured to perform one or more countermeasure actions, wherein the one or more countermeasure actions comprise altering signals associated with the portable device, wherein altering the signals comprises altering at least one of an operating frequency, an amplitude, or a phase of the signals associated with the portable device.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system for detecting and mitigating unauthorized access and tampering with respect to a portable device; and

FIG. 2 illustrates an example flow chart of a method of the system of FIG. 1.

### DETAILED DESCRIPTION

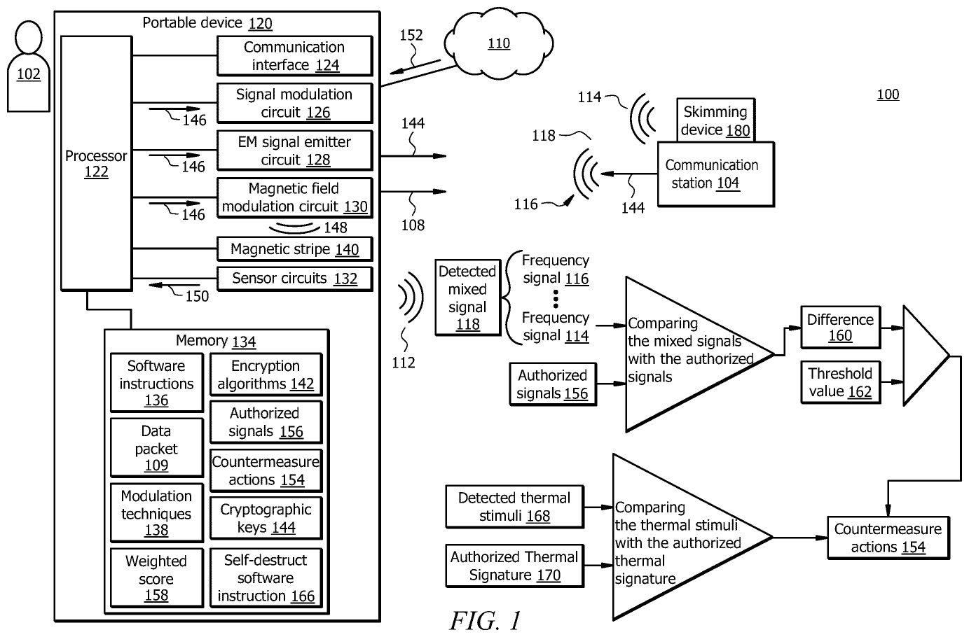

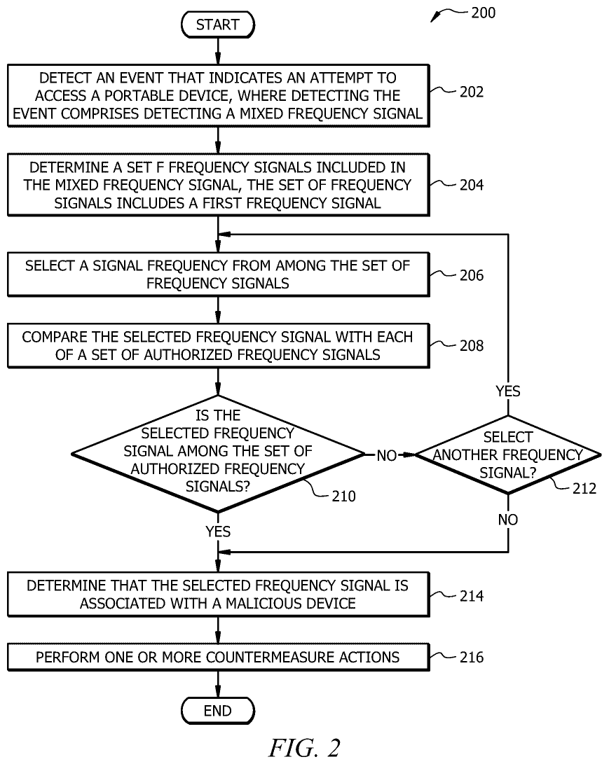

As described above, previous technologies fail to provide efficient and reliable solutions for detecting and mitigating unauthorized access and tampering with respect to a device. Embodiments of the present disclosure and its advantages may be understood by referring to FIGS. 1 through 2. FIGS. 1 through 2 are used to describe systems and methods for detecting and mitigating unauthorized access and tampering with respect to a device, according to some embodiments.

### System Overview

FIG. 1 illustrates an embodiment of a system 100 that is generally configured to detect and mitigate potential and actual skimming attempts to access information associated with a portable device. In some embodiments, the system 100 comprises a portable device 120. The portable devices 120 may be communicatively coupled to other computing devices via a network 110. In some embodiments, the system 100 comprises may further comprise a communication station 104. A user 102 may use the portable device 120 to perform certain operations, such as communicating with other devices (e.g., communication stations 104), sending and receiving data, and interacting with other devices, among others. In other embodiments, system 100 may not have all of the components listed and/or may have other elements instead of, or in addition to, those listed above.

In general, the system 100 improves the unauthorized access attempt detection and mitigation techniques with respect to unauthorized attempts to remotely access portable devices 120. In the current systems, skimming devices pose an ongoing threat, resulting in compromised data. Existing security measures necessitate the development of more robust solutions to safeguard against this form of fraud. The disclosed system 100 is configured to provide a technical solution to these and other technical problems in the realm of data and network security.

In some embodiments, the system 100 provides anti-skimming technology embedded in the portable device 120. The portable device 120 may employ a combination of dynamic security features to protect data that is accessible at and via the portable device 120. For example, in some embodiments, the system 100 may be configured to implement stealth mode activation, frequency jamming, randomized data encryption, dynamic magnetic stripe, and tamper detection mechanisms.

By implementing these technologies, the portable device 120 remains inaccessible to skimming devices 180, disrupts the functioning of the skimming devices 180, reduces the likelihood of data capture attempts from the skimming devices 180, reduces the likelihood of duplication of information stored in a memory of the portable device 120 and information accessible via the portable device 120, and addresses any tampering attempts by the skimming devices 180. In this way, the disclosed system 100 improves the detection and mitigation techniques for unauthorized access attempts via skimming devices. This, in turn, improves the network security techniques by detecting and mitigating remote access attempts from malicious devices that may be used to exfiltrate data accessible at and/or via portable devices.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may include fiber optics, optical fibers, and the like. The network 110 may be configured to support any suitable type of communication protocol as would be appreciated by one of ordinary skills in the art.

### Example Communication Station

The communication station 104 may be a computing device configured to process data and perform certain operations, including interacting with portable devices 120, and communicating data with other devices, among others. In some examples, the communication station 104 may be a kiosk, an automated teller machine, a card reader, a cash register, a dispensing machine, a scanning station, and/or the like. In some embodiments, the communication station 104 may be portable or stationary. In some embodiments, the communication station 104 may comprise a terminal device for dispensing items, tickets, scrip, airline tickets, displaying information on its display screen about a service or item, etc. In some embodiments, the communication station 104 may allow users 102 to withdraw cash, and check balances, and make deposits interactively using, for example, a magnetically encoded card, a check, etc., among other services that the communication station 104 provides.

This disclosure contemplates communication station 104 being any appropriate device for sending and receiving communications over network 110. The communication station 104 may include a user interface, such as a display, a microphone, a keypad, or other appropriate terminal equipment usable by users 102. The communication station 104 may include a hardware processor, memory, and/or circuitry configured to perform any of the functions or actions of communication station 104 described herein. For example, the communication station 104 may include a processor in signal communication with a memory and a network interface. The memory of the communication station 104 may store a software application designed using software code that when executed by the processor of the communication station 104, causes the processor of the communication station 104 to perform the functions of communication station 104.

### Example Portable Device

The portable device 120 may be a computing device configured to process data, detect the presence of skimming devices 180, and perform certain operations to mitigate the skimming device 180, among other operations. In some embodiments, the portable device 120 may be a thin apparatus that at least partially may be inserted into a slot of a kiosk (an example communication station 104), where the internal components of the kiosk may read and access information displayed on the portable device 120 and/or stored in the memory 134 of the portable device 120. In some embodiments, the portable device 120 may be configured to communicate data with the kiosk with wireless communication when the portable device 120 is within a threshold communication range from the kiosk.

In some embodiments, the portable device 120 may be configured to communicate with legitimate device communication stations 104 via wireless communication when the portable device 120 is within a threshold communication range from the legitimate device communication stations 104. In some embodiments, the portable device 120 may communicate with communication station 104 via wireless communication, such as NFC, Bluetooth, and the like. For example, portable device 120 may be a card device, a telephone, a mobile phone, a computer, a laptop, a tablet, an automated assistant, and/or a cash register. This disclosure contemplates portable device 120 being any appropriate device for sending and receiving communications over network 110. As an example and not by way of limitation, portable device 120 may be a computer, a laptop, a wireless or cellular telephone, an electronic notebook, a personal digital assistant, a tablet, or any other device capable of receiving, processing, storing, and/or communicating information with other components of system 100. The portable device 120 may also include a user interface, such as a display, a microphone, a keypad, or other appropriate terminal equipment usable by user 102. Portable device 120 may include a hardware processor, memory, and/or circuitry configured to perform any of the functions or actions of portable device 120 described herein. For example, a software application designed using software code may be stored in the memory and executed by the processor to perform the functions of portable device 120.

In some examples, the portable device 120 may be used to access a digital profile and digital wallet associated with a user 102. In the illustrated embodiment, the portable device 120 includes a processor 122 in signal communication with a communication interface 124, a signal modulation circuit 126, an electromagnetic signal emitter circuit 128, a magnetic field modulation circuit 130, sensor circuits 132, a, and a memory 134. The components of the portable device 120 may be implemented by nano, micro-electronic circuits, micro-electromechanical systems (MEMS), and other components. In certain embodiments, the portable device 120 may be configured as shown or in other configurations.

The processor 122 comprises one or more processors. The processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The one or more processors are configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations, processor 122 registers the supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions (e.g., software instructions 137) to implement the operations of the processor 122. In this way, processor 122 may be a special-purpose computer designed to implement the functions disclosed herein. In an embodiment, the processor 122 is implemented using logic units, FPGAs, ASICs, DSPs, or any other suitable hardware. The processor 122 is configured to operate as described in FIGS. 1-2. For example, the processor 122 may be configured to perform one or more operations of the operational flow of the system 100 described in FIG. 1 and one or more operations of method 200 as described in FIG. 2.

Communication interface 124 is configured to enable wired and/or wireless communications (e.g., via network 110). The communication interface 124 is configured to communicate data between the portable device 120 and other devices, systems, and domains. For example, the communication interface 124 may comprise an embedded subscriber identity module (eSIM) interface, NFC interface, a Bluetooth interface, a Zigbee interface, a Z-Wave interface, a radio-frequency identification (RFID) interface, a Wi-Fi interface, a LAN interface, a WAN interface, a MAN interface, a PAN interface, a WPAN interface, a modem, a switch, and/or a router. The processor 122 is configured to send and receive data using the communication interface 124. The communication interface 124 may be configured to use any suitable type of communication protocol as would be appreciated by one of ordinary skill in the art.

Memory 134 may be a non-transitory computer-readable medium. The Memory 134 may be volatile or non-volatile storage device. The Memory 134 may comprise a read-only memory (ROM), random-access memory (RAM), ternary content-addressable memory (TCAM), dynamic random-access memory (DRAM), and static random-access memory (SRAM). Memory 134 may be implemented using one or more disks, tape drives, solid-state drives, and/or the like. Memory 134 is operable to store the software instructions 172, and/or any other data or instructions. The software instructions 172 may comprise any suitable set of instructions 186, logic, rules, or code operable to execute the operations of the processor 122.

### Signal Modulation Circuit

The signal modulation circuit 126 may be implemented in hardware (e.g., ASIC) and/or software (e.g., as a part of the software instructions 136) executed on a microcontroller (e.g., included in the processor 122), and is generally configured to modulate implement one or more signal modulation techniques 138 for data transmissions from the portable device 120. In some examples, the signal modulation techniques 138 may include frequency hopping spread spectrum (FHSS), direct sequence spread spectrum (DSSS), amplitude modulation (AM), frequency modulation (FM), and quadrature amplitude modulation (QAM), among others. The modulation techniques 138 are configured to change the frequency, amplitude, and/or phase of the signals 108, to make the signals 108 challenging to detect or intercept from an unauthorized device, such as the skimming device 180.

In some embodiments, the signal modulation circuit 126 may include a phase lock loop (PLL) circuit, signal mixer circuits, and filter circuits, among others. The signal modulation circuit 126 may be configured to change the modulation method and/or parameters for each signal 108. For example, the PLL may lock into a frequency during FHSS operation for transmitting the modulated signal 108. The mixer circuit may combine the input signal with a local oscillator signal to produce a modulated signal 108. The filter circuit may include a low-pass, band-pass, and/or high-pass filter circuit configured to filter or disregard unwanted frequencies from the signal 108 before and after modulation. The signal modulation circuit 126 may be triggered to modulate each signal 108 to be transmitted. The signal 108 may include data packets that are queued in an outgoing buffer of the communication interface 124 to be transmitted.

In some embodiments, the portable device 120 is configured to implement a resonance cloaking technique. The resonance cloaking technique utilizes metamaterials or specially designed structures to manipulate electromagnetic waves. By matching the resonance frequency of the card with its surroundings, it essentially disappears from electromagnetic detection, reducing the likelihood of skimming attempts from an unauthorized device, such as the skimming device 180.

### Electromagnetic Signal Emitter Circuit

The electromagnetic signal emitter circuit 128 may be implemented by hardware comprising circuits and configured to generate and emit electromagnetic noise signals 112. For example, the electromagnetic signal emitter circuit 128 may emit electromagnetic noise signals 112 across a broad spectrum of frequencies to interfere with the signals used by skimming devices 180. For example, the electromagnetic noise signals 112 may be in frequency bands of 13.56 megahertz (MHz), 125 kilohertz (KHz), and 2.4 gigahertz (GHz) which are commonly used by various communication devices, such as RFID and NFC, which are often targeted by skimming devices 180.

The electromagnetic noise signals 112 may disrupt the skimming device 180's ability to read data from the magnetic chip or magnetic stripe 140 associated with the portable device 120. The portable device 120 may monitor the electromagnetic environment surrounding it. If the portable device 120 detects both the signals 116, and 114 from a legitimate communication station 104 and a skimming device 180 respectively, the portable device 120 may remain dormant to reduce the likelihood of unauthorized data access attempts from the skimming device 180. In some embodiments, the portable device 120 may remain dormant by going into a sleep mode, in which the portable device 120 does not respond to external signals and does not initiate a signal transmission, among others. For example, in some embodiments, in response to detecting the presence of a skimming device 180, the processor 122 may execute code (included in the software instructions 136) to enter the sleep mode. Various methods for detecting the presence of the skimming device 180 are described further below. If a skimming device 180 is on top/inside (internal/overlay) of a legitimate communication station 104, they may produce a mixed signal 118. The portable device 120 may detect the mixed signal 118 and it may trigger the portable device 120 to enter the sleep mode.

### Altering Encryptions

In some embodiments, the portable device 120 may implement a method to dynamically alter the encryption algorithms 142 to encrypt the signals 112. In some examples, the encryption algorithms 142 may include advanced encryption standard (AES), among others to encode or decrypt the signals 112 before transmission. The portable device 120 may periodically (e.g., every second, every thirty seconds, etc.) change the encryption keys and data patterns (e.g., data format, data schema) associated with the data included or encoded in the signals 112. Thus, the encrypted signals 112 may be more difficult to exfiltrate due to the nature of dynamic alterations in the encryption compared to using a static encryption key. In some embodiments, the portable device 120 may implement a random number generator to generate dynamic encryption keys and/or alter data patterns for the signals 112.

In some embodiments, before a data transmission between the portable device 120 and the communication station 104, the portable device 120 and the communication station 104 may perform a secure handshake by exchanging cryptographic keys 144. In this process, the portable device 120 and the communication station 104 may use public and private encryption keys. Each of the portable device 120 and the communication station 104 may use its private key to decrypt data that is encrypted with its public key which is shared between the portable device 120 and the communication station 104 during the handshake.

### Magnetic Field Modulation Circuit

The magnetic field modulation circuit 130 may include hardware circuits configured to alter or change the magnetic properties of the magnetic stripe 140. The magnetic stripe 140 may be made of materials with properties that allow for dynamic changes in magnetic fields generated by the magnetic stripe 140. For example, the magnetic stripe 140 may be made of ferrofluids or magnetorheological elastomers whose magnetic properties may be altered in response to external stimuli.

In some embodiments, when triggered by the detection of skimming activity, the magnetic field modulation circuit 130 may apply controlled alterations to the magnetic field of stripe 140, making it at least partially unreadable by unauthorized skimming devices 180. The magnetic field modulation circuit 130 may include control circuitry, power supply, and feedback loop circuit. The magnetic field modulation circuit 130 may include hardware circuits, coils, and/or other magnetic field generators capable of emitting electromagnetic fields with specific properties. These electromagnetic fields are directed towards the magnetic stripe 140 upon activation, inducing controlled changes in its magnetic characteristics. For example, the processor 122 may send an instruction 146 to the electromagnetic field modulation circuit 130 indicating to initiate altering the magnetic field of the magnetic stripe 140. In response, the magnetic field modulation circuit 130 may generate and emit electromagnetic fields 148 toward the magnetic stripe 140 to alter its magnetic characteristics.

In some embodiments, the magnetic field modulation circuit 130 may periodically (e.g., every second, every thirty seconds, etc.) alter the magnetic characteristics of the magnetic stripe 140. In this way, the magnetic stripe 140 may be at least partially unreadable/incoherent to the skimming device 180. The skimming device 180 not being able to read/access the magnetic stripe 140 leads to reducing the likelihood of instances of unauthorized data extraction by the skimming device 180.

The control circuitry may comprise a hardware circuit configured to control the operation of the magnetic field modulation circuit 130, e.g., based on the instructions 146. The processor 122 (e.g., via the sensor data 150) may determine whether there is an indication of the presence of unauthorized skimming activity in the sensor data 150. If it is determined that the sensor data 150 includes an indication of the presence of the unauthorized skimming activity, the processor 122 may coordinate the activation of the magnetic field modulation circuit 130 by sending the instruction 146 to initiate the countermeasure response. The power supply may include a hardware circuit configured to provide power to the components of the magnetic field modulation circuit 130. The feedback loop circuit may be a hardware circuit configured to maintain the effectiveness and performance of the magnetic modulation process. The feedback loop circuit enables the monitoring of the countermeasure actions'impact and adjusts the modulation parameters as needed to render the magnetic stripe 140 at least partially unreadable/incoherent to the skimming device 180.

### Sensor Circuits

The sensor circuit 132 may include hardware sensor circuits, including but not limited to accelerometers, gyroscopes, and tamper switches. The accelerometers, gyroscopes, and tamper switches may be used to detect physical tampering or unauthorized access. For example, certain sensor circuits 132 may detect a physical tampering event in response to detecting an abnormal movement of the portable device 120, such as accelerations, a movement during an event that historically deviates from historical movements of the portable device 120 during the event, orientations that deviate from historical orientation patterns, among others. Upon detection of a skimming activity, the processor 122 may trigger self-destructive mechanisms, such as erasing at least a part of the data stored in the memory 134 and disabling certain functionalities to protect sensitive information, among others.

In some embodiments, the portable device 120 may be equipped with a remote location identification method so that a user may locate the geographical location of the portable device 120. The user may remotely activate the self-destructive mechanism of the portable device 120. In response, the portable device 120 may receive a signal 152 (e.g., via the network 110) that indicates to perform the self-destructive mechanism. In response, the portable device 120 may perform the self-destructive mechanism. In some embodiments, the sensor circuits 132 may include an electromagnetic field sensor, frequency signal detector, thermal sensor, and biometric feature sensor.

In some embodiments, the portable device 120 may be formed or constructed from certain materials, including but not limited to mu-metal alloys, and conductive fabrics, such as copper or silver-coated textiles, among others. These materials may provide the ability to block or absorb electromagnetic signals, making the portable device 120 resistant to skimming attempts. In some embodiments, the portable device 120 may remain inactive (e.g., in sleep mode) until it is activated by the user 102. For example, in some embodiments, the portable device 120 may validate the identity of the user 102 based on the credentials provided by the user 102 to the portable device 120, fingerprint associated with the user 102 when the user 102 handles the portable device 120, among others. Otherwise, the portable device 120 may be in the sleep mode.

In some embodiments, when not in use, the portable device 120 may enter a low-power sleep mode to conserve energy and not be activated in response to skimming attempts. When activated by thermal stimuli or specific gestures, the processor 122 (e.g., via a sensor circuit 132) may detect the thermal stimuli or the specific gestures and awaken the portable device 120, bringing it out of sleep mode. In some embodiments, the portable device 120 may exit the sleep mode in response to the user 102 providing their credentials to the portable device 120.

The magnetic stripe 140 may be a thin strip of a magnetic material configured to store information encoded into the stripe, e.g., on the tracks of the stripe. In some examples, the information encoded may include user information, such as name, address, number, etc. The data stored on the magnetic stripe 140 may be read by a magnetic head in a magnetic reader associated with a skimming device 180 and/or the communication station 104.

### Operational Flow for Detecting and Mitigating Unauthorized Access and Tampering With Respect to a Device

In operation, the portable device may perform one or more countermeasure actions 154 in response to the detection of an anomalous event that may indicate an unauthorized attempt to access the portable device 120, such as skimming attempts by the skimming device 180. In an example scenario, the user 102 may carry the portable device 120 to a place where a skimming device 180 may be present, e.g., installed next to a legitimate communication station 104. The user 102 may want to use the communication station 104 to scan the portable device 120 or perform an action via the portable device 120.

### Detecting a Presence of the Skimming Device

In an example scenario, the sensor circuits 132 may capture signals, electromagnetic waves, thermal readings, etc., from their surroundings and provide sensor data 150 indicating the captured data to the processor 122 for analysis and determine whether any anomaly or deviation is present in the sensor data 150 compared to historical sensor data 150. The operational flow of the system 100 may begin when an anomalous event is detected.

In some embodiments, the portable device 120 may detect the anomalous event based on the sensor data 150 provided by the sensor circuits 132. The sensor data 150 may include indications of signals 114, 116, 118, electromagnetic wave data feed, and thermal data feed, among others. The portable device 120 may detect an event that may indicate an attempt to access the portable device 120. In some examples, the event may include detecting a mixed signal 118, e.g., associated with the skimming device 180 and the communication station 104, detecting mixed electromagnetic waves, e.g., associated with the skimming device 180 and communication station 104, thermal data feed, e.g., associated with the skimming device 180 and the communication station 104.

In an example scenario, an attempt to access the portable device 120 may include the use of skimming devices installed underneath keypads or embedded within legitimate communication station 104. When the user 102 intended to use the legitimate communication station 104, the user 102 may not be aware that the skimming device 180 is installed to either send signals 114 that mimic legitimate device communications or used to scan the portable device 120 to capture data from the magnetic stripe 140.

In some embodiments, the sensor circuits 132 (e.g., the signal frequency detector circuit) may detect the mixed signal 118 that may include the signals 114 and 116. The sensor circuit 132 may communicate the sensor data 150 to the processor 122. The processor 122 may analyze the sensor data 150 to determine whether it includes any indication of anomaly or deviation from historically known sensor data 150. To this end, the processor 122 may determine a set of frequency signals 114 and 116 associated with or included in the mixed signal 118. In this process, the processor 122 may determine the frequency signal components of the mixed signal 118 by demodulating the mixed signal 118 and separating it into its frequency signal components. For example, the processor 122 may perform fast fourier transform (FFT), frequency signal sampling, among other techniques. In performing the FFT operation, the processor 122 may convert the mixed signal 118 from the time domain into frequency domain to identify the individual frequency signals 114 and 116 included in the mixed signal 118.

The processor 122 may evaluate each frequency signal 114 and 116 against a list of authorized frequency signals 156. The authorized frequency signals 156 may include historical frequency signals that are known to be associated with legitimate communication stations 104. The processor 122 may compare the frequency signal 116 with each of the set of authorized frequency signals 156. In the example of FIG. 1, because the frequency signal 116 is associated with the communication station 104, the frequency signal 116 is included in the authorized frequency signals 156. Thus, the processor 122 may determine that the frequency signal 116 is associated with an authorized device.

The processor 122 may compare the frequency signal 114 with each of the set of authorized frequency signals 156. In the example of FIG. 1, the processor 122 may determine that the frequency signal 114 is not among the set of authorized frequency signals 156. In response, the processor 122 may determine that frequency signal 114 is associated with a malicious skimming device 180. In response, the processor 122 may perform one or more countermeasure actions 154.

In some embodiments, each authorized frequency signal 156 may have a range to allow for flexibility in the detection of authorized signals from authorized devices. For example, the frequency range may account for minor variations in frequency due to environmental factors, among others. For example, each authorized frequency signal 156 may be defined by a threshold range around the respective frequency, such as plus or minus a certain percentage or set number of hertz, e.g., ±5 KHz.

In some embodiments, the processor 122 may extract a set of features from each detected frequency signal 114 and 116, where the set of features may include amplitude, modulation scheme, frequency, power level, phase, etc. The processor 122 may evaluate each frequency signal 114 and 116 based on its features. For example, the processor 122 may compare each feature of the frequency signal 114 with a corresponding feature of a first authorized frequency signal 156. The processor 122 may determine a difference 160 between the frequency signal 114 and each authorized frequency signal 156. For example, the processor 122 may determine a difference 160 between each corresponding pair of features associated with the frequency signal 114 and authorized signal 156.

The processor 122 may assign a weight to each difference 160 between a pair of corresponding features based on historical indications of whether the feature is associated with a skimming device. For example, the processor 122 may assign a higher weight to the difference 160 between the frequency and modulation scheme features (associated with the frequency signal 114 and authorized signal 156) compared to amplitude and/or phase features because the amplitude and/or phase features may vary due to environmental factors, whereas the frequency and modulation scheme may be more indicative of the signal characteristics.

The processor 122 may aggregate the differences 160 to determine an overall weighted sum of differences 160 that indicates a discrepancy score for the frequency signal 114 in relation to each authorized frequency signal 156. Based on the weighted sum of differences 160, the processor 122 may determine whether the frequency signal 114 falls within a threshold range of any of the authorized frequency signals 156. In this process, the processor 122 may determine whether the determined difference 160 is more than a threshold value 162. For example, the threshold value 162 may be within the range of 10%, 30%, etc., deviation from the authorized signal 156. If it is determined that the difference 160 (e.g., the weighted sum of the differences 160) is more than the threshold value 162, the processor 122 may determine that the frequency signal 114 is associated with a malicious skimming device 180. In response, the processor 122 may perform one or more countermeasure actions 154.

In some embodiments, the processor 122 may perform similar operations for electromagnetic signals in addition to or instead of frequency signals 114, 116. For example, the processor 122 may evaluate the electromagnetic signals included in the sensor data 150 and in response to detecting a deviation from expected electromagnetic signals in the sensor data 150, where the deviation is more than a threshold value 162, the processor 122 may perform one or more countermeasure actions 154.

In some embodiments, the portable device 120 may detect a presence of a skimming device 180 in response to detecting thermal stimuli, such as the warmth from the skimming device 180 detected by the thermal sensor of the portable device 120 when the skimming device 180 is within a detection range of the thermal sensor. For example, the thermal sensor circuit (included in the sensor circuits 132) may be used to detect thermal data (included in the sensor data 150) of the surrounding environment. The anomalous event detection may include detecting thermal stimuli from the skimming device 180. The processor 122 may compare the detected thermal stimuli 168 with an expected thermal signature 170 associated with the authorized communication station 104. The processor 122 may determine that the detected thermal stimuli 168 deviates from the expected thermal signature 170 for more than a threshold value (e.g., more than one degree, two degrees, etc.). In response, the processor 122 may perform one or more countermeasure actions 154.

### Mitigating the Skimming Attempt

In response to detecting the presence of the skimming device 180 and/or determining that the mixed signal 118 includes a signal 114 associated with the skimming device 180, the processor 122 may perform one or more countermeasure actions 154. To this end, the processor 122 may generate the instructions 146 and communicate them to the various components of the portable device 120 to perform the countermeasure action 154. For example, in some embodiments, the processor 122 may communicate the instructions 146 to the signal modulation circuit 126, where the instructions 146 indicate to initiate altering the modulation of the signals 108, similar to that described above. For example, a countermeasure action 154 may include altering signals 108 by altering the operating frequency, amplitude, and/or phase of the signals 108, for example by performing FHSS, DSSS, among others.

In some embodiments, the processor 122 may communicate the instructions 146 to the electromagnetic signal emitter circuit 128, where the instructions 146 indicate to emit an electromagnetic noise signal 112 at one or more frequency bands or across a wide spectrum, similar to that described above. For example, a countermeasure action 154 may include emitting the electromagnetic noise signal 112 with certain parameters, such as amplitude, frequency range, direction, etc. These parameters may be preconfigured.

In some embodiments, the processor 122 may communicate the instructions 146 to the magnetic field modulation circuit 130, where the instructions 146 indicate to alter the magnetic properties of the magnetic stripe 140 by emitting the electromagnetic field 148 toward the magnetic stripe 140. For example, a countermeasure action 154 may include altering one or more magnetic field properties associated with magnetic stripe 140, including a magnetic signal frequency, a magnetic signal amplitude, magnetic orientation, or a bit stream associated with the magnetic stripe 140. The bit stream may be a sequence of binary data that encodes information stored on the magnetic stripe 140, such as user information, documents, numbers, addresses, and other relevant data.

In some embodiments, the countermeasure actions 154 may include executing the self-destruct software instructions 166 that include code that indicates to ease at least a part of the information stored in the memory 134. In response to the self-destruct software instructions 166, at least part of the information stored in the memory 134 may be erased.

In some embodiments, the countermeasure actions 154 may include implementing a set of encryption algorithms 142 for data packet transmissions (e.g., signals 108) at various timestamps. For example, the first encryption algorithm 142 may be used to encrypt a first data packet for transmission at a first timestamp, and a second encryption algorithm 142 may be used to encrypt a second data packet for transmission at a second timestamp.

### Method for Detecting and Mitigating Unauthorized Access and Tampering With Respect to a Device

FIG. 2 illustrates an example flowchart of a method 200 for detecting and mitigating unauthorized access and tampering with respect to a device, according to some embodiments. Modifications, additions, or omissions may be made to method 200. Method 200 may include more, fewer, or other operations. For example, operations may be performed in parallel or in any suitable order. While at times, it is discussed that the system 100, portable device 120, or components of any thereof perform some operations, any suitable system or components of the system may perform one or more operations of the method 200. For example, one or more operations of method 200 may be implemented, at least in part, in the form of software instructions 136 of FIG. 1, stored on a tangible non-transitory machine-readable medium (e.g., memory 134 of FIG. 1) that, when run by one or more processors (e.g., processor 122 of FIG. 1), may cause the one or more processors to perform operations 202-216.

At operation 202, the portable device 120 detects an event that indicates an attempt to access the portable device 120, where detecting the vent comprises detecting a mixed signal 118, e.g., from skimming device 180 and/or communication station 104, similar to that described in FIG. 1. In some embodiments, the event detection process may include detecting electromagnetic waves and thermal stimuli, similar to that described in FIG. 1.

At operation 204, the portable device 120 determines a set of frequency signals included in the mixed frequency signal 118, the set of frequency signals may include the first frequency signal 114.

At operation 206, the portable device 120 selects a frequency signal from among the set of frequency signals 114 and 116. The portable device 120 may iteratively select a frequency signal until no frequency signal is left for evaluation.

At operation 208, the portable device 120 compares the selected frequency signal with each of the authorized frequency signals 156, similar to that described in FIG. 1.

At operation 210, the portable device 120 determines whether the selected frequency signal is among the set of authorized frequency signals 156, similar to that described in FIG. 1. If it is determined that the selected frequency signal is among the set of authorized frequency signals 156, the method 200 proceeds to operation 212. Otherwise, the method 200 proceeds to operation 214.

At operation 212, the portable device 120 determines whether to select another frequency signal from the mixed signal 118. If it is determined that no frequency signal is left for evaluation, the method 200 proceeds to operation 214. Otherwise, the method 200 returns to operation 206.

At operation 214, the portable device 120 determines that the selected frequency signal 114 is associated with a malicious device, e.g., skimming device 180.

At operation 216, the portable device 120 performs one or more countermeasure actions 154.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory configured to store a set of authorized frequencies associated with an authorized device; and
a processor, operably coupled with the memory, and configured to:
detect an event that indicates an attempt to access a portable device, wherein detecting the event comprises detecting a mixed frequency signal associated with at least an external device;
determine that a set of frequencies associated with the mixed frequency signal comprises a first frequency;
compare the first frequency with the set of authorized frequencies;
determine that the first frequency is not among the set of authorized frequencies; and
in response to determining that the first frequency is not among the set of authorized frequencies:
determine that the first frequency is associated with a malicious device; and
perform one or more countermeasure actions, wherein the one or more countermeasure actions comprise altering signals associated with the portable device, wherein altering the signals comprises altering at least one of an operating frequency, an amplitude, or a phase of the signals associated with the portable device.

2. The system of claim 1, wherein:
the system further comprises an electromagnetic signal emitter circuit configured to emit electromagnetic signals; and
the one or more countermeasure actions further comprise emitting, by the electromagnetic signal emitter circuit, an electromagnetic noise signal at one or more frequency bands.

3. The system of claim 1, wherein:
the system further comprises a thermal sensor configured to detect thermal data of a surrounding environment;
detecting the event further comprises detecting by the thermal sensor a thermal stimuli from the external device; and
the processor is further configured to:
compare the detected thermal stimuli with an expected thermal signature associated with the authorized device;
determine that the detected thermal stimuli deviate from the expected thermal signature more than a threshold value; and
perform the one or more countermeasure actions in response to determining that the detected thermal stimuli deviate from the expected thermal signature more than the threshold value.

4. The system of claim 1, wherein the one or more countermeasure actions further comprise:
implementing a set of encryption algorithms for data packet transmission at various timestamps, comprising;
encrypting a first data packet with a first encryption algorithm for transmission at a first timestamp; and
encrypting a second data packet with a second encryption algorithm for transmission at a second timestamp.

5. The system of claim 1, wherein the one or more countermeasure actions further comprise altering one or more magnetic field properties associated with a magnetic stripe associated with the portable device, wherein the one or more magnetic field properties comprise a magnetic orientation.

6. The system of claim 1, wherein the one or more countermeasure actions further comprise executing a self-destruct software instruction, wherein in response to the self-destruct software instruction being executed, information stored at the portable device is erased.

7. The system of claim 1, wherein the one or more countermeasure actions further comprise performing frequency hopping spread spectrum (FHSS) or direct sequence spread spectrum (DSSS) to alter the signals associated with the portable device.

8. A method comprising:
detecting an event that indicates an attempt to access a portable device, wherein detecting the event comprises detecting a mixed frequency signal associated with at least an external device;
determining that a set of frequencies associated with the mixed frequency signal comprises a first frequency;
comparing the first frequency with a set of authorized frequencies;
determining that the first frequency is not among the set of authorized frequencies; and
in response to determining that the first frequency is not among the set of authorized frequencies:
determining that the first frequency is associated with a malicious device; and
performing one or more countermeasure actions, wherein the one or more countermeasure actions comprise altering signals associated with the portable device, wherein altering the signals comprises altering at least one of an operating frequency, an amplitude, or a phase of the signals associated with the portable device.

9. The method of claim 8, wherein:
the one or more countermeasure actions further comprise emitting, by an electromagnetic signal emitter circuit, an electromagnetic noise signal at one or more frequency bands.

10. The method of claim 8, wherein:
detecting the event further comprises detecting by a thermal sensor a thermal stimuli from the external device; and
the method further comprises:
comparing the detected thermal stimuli with an expected thermal signature associated with an authorized device;
determining that the detected thermal stimuli deviate from the expected thermal signature more than a threshold value; and
performing the one or more countermeasure actions in response to determining that the detected thermal stimuli deviate from the expected thermal signature more than the threshold value.

11. The method of claim 8, wherein the one or more countermeasure actions further comprise:
implementing a set of encryption algorithms for data packet transmission at various timestamps, comprising;
encrypting a first data packet with a first encryption algorithm for transmission at a first timestamp; and
encrypting a second data packet with a second encryption algorithm for transmission at a second timestamp.

12. The method of claim 8, wherein the one or more countermeasure actions further comprise altering one or more magnetic field properties associated with a magnetic stripe associated with the portable device, wherein the one or more magnetic field properties comprise a magnetic orientation.

13. The method of claim 8, wherein the one or more countermeasure actions further comprise executing a self-destruct software instruction, wherein in response to the self-destruct software instruction being executed, information stored at the portable device is erased.

14. The method of claim 8, wherein the one or more countermeasure actions further comprise performing frequency hopping spread spectrum (FHSS) or direct sequence spread spectrum (DSSS) to alter the signals associated with the portable device.

15. A non-transitory computer-readable medium that stores instructions, wherein when the instructions are executed by a processor, cause the processor to:
detect an event that indicates an attempt to access a portable device, wherein detecting the event comprises detecting a mixed frequency signal associated with at least an external device;
determine that a set of frequencies associated with the mixed frequency signal comprises a first frequency;
compare the first frequency with a set of authorized frequencies;
determining that the first frequency is not among the set of authorized frequencies; and
in response to determining that the first frequency is not among the set of authorized frequencies:
determining that the first frequency is associated with a malicious device; and
performing one or more countermeasure actions, wherein the one or more countermeasure actions comprise altering signals associated with the portable device, wherein altering the signals comprises altering at least one of an operating frequency, an amplitude, or a phase of the signals associated with the portable device.

16. The non-transitory computer-readable medium of claim 15, wherein:
the one or more countermeasure actions further comprise emitting, by an electromagnetic signal emitter circuit, an electromagnetic noise signal at one or more frequency bands.

17. The non-transitory computer-readable medium of claim 15, wherein:
detecting the event further comprises detecting by a thermal sensor a thermal stimuli from the external device; and
the instructions further cause the processor to:
compare the detected thermal stimuli with an expected thermal signature associated with an authorized device;
determine that the detected thermal stimuli deviate from the expected thermal signature more than a threshold value; and
perform the one or more countermeasure actions in response to determining that the detected thermal stimuli deviate from the expected thermal signature more than the threshold value.

18. The non-transitory computer-readable medium of claim 15, wherein the one or more countermeasure actions further comprise:
implementing a set of encryption algorithms for data packet transmission at various timestamps, comprising;
encrypting a first data packet with a first encryption algorithm for transmission at a first timestamp; and
encrypting a second data packet with a second encryption algorithm for transmission at a second timestamp.

19. The non-transitory computer-readable medium of claim 15, wherein the one or more countermeasure actions further comprise altering one or more magnetic field properties associated with a magnetic stripe associated with the portable device, wherein the one or more magnetic field properties comprise a magnetic orientation.

20. The non-transitory computer-readable medium of claim 15, wherein the one or more countermeasure actions further comprise executing a self-destruct software instruction, wherein in response to the self-destruct software instruction being executed, information stored at the portable device is erased.
